(19) United States
(12) Patent Application Publication
(10) Pub. No.: US 2020/0326690 A1
(43) Pub. Date: Oct. 15, 2020

(54) MACHINERY MANAGEMENT SYSTEM

(71) Applicant: JTEKT CORPORATION, Osaka-shi (JP)

(72) Inventors: Tomonari OGI, Obu-shi (JP); Sakon MURAYAMA, Kariya-shi (JP)

(73) Assignee: JTEKT CORPORATION, Osaka-shi (JP)

(21) Appl. No.: 16/842,853

(22) Filed: Apr. 8, 2020

(30) Foreign Application Priority Data
Apr. 9, 2019 (JP) 2019-074105

(51) Int. Cl. G05B 19/418; G07C 3/08

(52) U.S. Cl. CPC G05B 19/4184; G07C 3/08; G05B 19/4183

(57) ABSTRACT

A machinery management system includes: an optical detection sensor unit including an optical detection sensor that is disposed to face an indicator lamp configured to indicate a machine state and that detects a light from the indicator lamp, and a first optical detection sensor terminal that is connected to the optical detection sensor; a communication unit including a body portion that is disposed on the indicator lamp, a communication unit terminal that is detachably attached to the first optical detection sensor terminal, and a communication processing portion that connects with the optical detection sensor; and a machine state management apparatus including a management communication portion that wirelessly communicates with the communication processing portion, and an information display portion that displays an information of the optical detection signal generated by the optical detection sensor, the information being communicated through the management communication portion.

### CROSS-REFERENCE TO RELATED APPLICATIONS

This application is based on and claims priority under 35 USC 119 from Japanese Patent Application No. 2019-074105 filed on Apr. 9, 2019, the contents of which are incorporated herein by reference.

### TECHNICAL FIELD

The present disclosure relates to a machinery management system.

### BACKGROUND ART

In the configuration of a machinery management system, a state of a machine can be sent from the machine to the outside so that a worker or an administrator can grasp the machine state easily so as to improve production efficiency. Change of an existing piece of control equipment such as change of software (a ladder circuit) of a control controller (PLC) of the machine or addition of a new piece of control equipment into an existing control panel such as addition of a relay component for fetching an input signal into the PLC is required for sending the machine state from the machine to the outside. Accordingly, cost or the number of manhours increases.

A device including an optical detection sensor which is provided in an indicator lamp capable of indicating a state of a machine and through which the machine state can be sent from the machine to the outside has been disclosed in JP2004-006291A. That is, the device detects light of the indicator lamp through the optical detection sensor, and sends an optical detection signal expressing the machine state from the machine to the outside through a wireless communication device. According to the device, change of an existing piece of control equipment or addition of a new piece of control equipment into an existing control panel becomes unnecessary. Accordingly, an increase of cost or the number of manhours can be suppressed.

However, the device including the optical detection sensor as disclosed in JP2004-006291A is configured to be incorporated into the indicator lamp of the machine in advance. Therefore, when the indicator lamp has been changed to a new one, a device provided with a new optical detection sensor corresponding to the newly changed indicator lamp has to be incorporated accordingly.

### SUMMARY OF INVENTION

The present disclosure is to provide a machinery management system in which a device provided with an optical detection sensor can be simply installed on an indicator lamp which can indicate a machine state.

According to an illustrative aspect of the present disclosure, a machinery management system includes: at least one optical detection sensor unit including an optical detection sensor that is disposed to face an indicator lamp configured to indicate a machine state and that detects a light from the indicator lamp, and a first optical detection sensor terminal that is connected to the optical detection sensor; at least one communication unit including a body portion that is disposed on the indicator lamp, a communication unit terminal that is detachably attached to the first optical detection sensor terminal, and a communication processing portion that is configured to connect with the optical detection sensor, such that an optical detection signal generated by the optical detection sensor is wirelessly communicated; and at least one machine state management apparatus including a management communication portion that is configured to wirelessly communicate with the communication processing portion, and an information display portion that is configured to display an information of the optical detection signal generated by the optical detection sensor, the information being communicated through the management communication portion.

The communication unit of the machinery management system is provided with the communication unit terminal to which the first optical detection sensor terminal of the optical detection sensor unit is detachably attached. Therefore, even when the indicator lamp has been changed to a new one, this change can be coped with by replacing only the optical detection sensor unit with a new optical detection sensor unit corresponding to the newly changed indicator lamp. Accordingly, simple installation can be possible so that an increase of installation cost can be suppressed.

### BRIEF DESCRIPTION OF DRAWINGS

FIG. 1 is a schematic view of a machinery management system according to an embodiment of the present disclosure.

FIG. 2A is a view showing details of a communication unit disposed on an indicator lamp of a machine in the machinery management system, and optical detection sensor units connected to the communication unit.

FIG. 2B is a view of FIG. 2 which has been turned around a vertical axis of the indicator lamp by 90°.

FIG. 3A is a view showing details of each of the optical detection sensor units.

FIG. 3B is a view showing a state in which the three optical detection sensor units have been connected to one another.

FIG. 4 is a view showing a machine matter detection sensor unit for connecting a machine matter detection sensor to the communication unit.

FIG. 5A is a flow chart for explaining a first half of operation of the machinery management system.

FIG. 5B is a flow chart for explaining a second half of the operation of the machinery management system.

FIG. 6 is a view showing a machine selection screen displayed on a mobile information display portion of a mobile terminal unit.

FIG. 7 is a view showing a machine state selection screen about a machine displayed on the mobile information display portion of the mobile terminal unit.

FIG. 8 is a view showing integrated information about the machine displayed on a management information display portion of a machine state management apparatus (the mobile information display portion of the mobile terminal unit).

FIG. 9 is a view showing a planned number of products and an actual number of products displayed on the management information display portion of the machine state management apparatus (the mobile information display portion of the mobile terminal unit).

FIG. 10 is a view showing planned operational availability and actual operational availability displayed on the management information display portion of the machine state management apparatus (the mobile information display portion of the mobile terminal unit).

FIG. 11 is a view showing a planned operating time and an actual operating time displayed on the management information display portion of the machine state management apparatus (the mobile information display portion of the mobile terminal unit).

### DESCRIPTION OF EMBODIMENTS

### (1. Configuration of Machinery Management System)

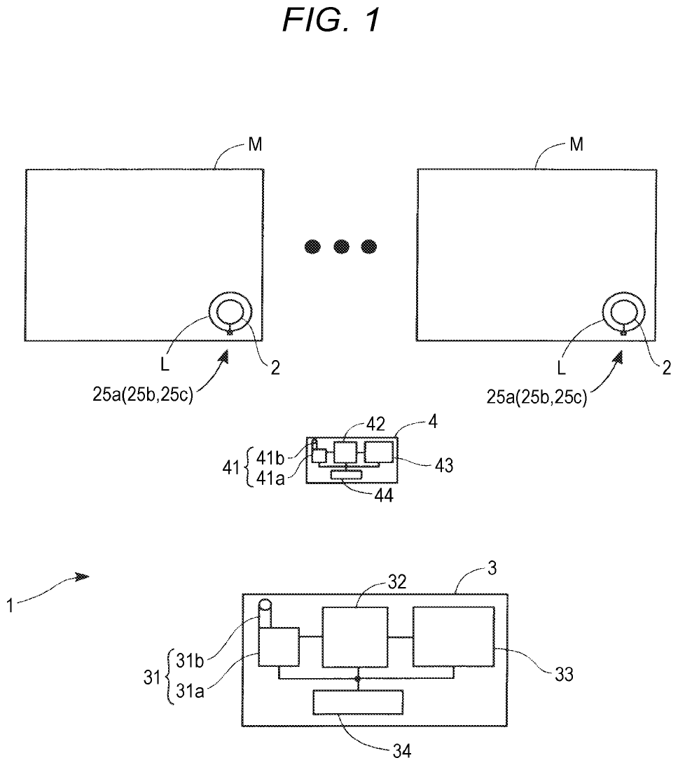

A machinery management system according to an embodiment of the present disclosure will be described with reference to the drawings. As shown in FIG. 1, the machinery management system 1 is a system managing a plurality of machines M. The machinery management system 1 is provided with optical detection sensor units 25a, 25b and 25c, communication units 2, a machine state management apparatus 3, a mobile terminal unit 4, etc. The optical detection sensor units 25a, 25b and 25c detect lights of indicator lamps L of the machines M respectively. The communication units 2 can make wireless communication for transmitting optical detection signals from the optical detection sensor units 25a, 25b and 25c. The machine state management apparatus 3 makes wire communication with the communication units 2 so as to manage machine states of the machines M collectively. The mobile terminal unit 4 make wireless communication with the machine state management apparatus 3 and can be carried by a worker etc. so that the worker etc. can confirm the machine states.

Each of the machines M is, for example, a working apparatus which can cut or grind a workpiece. The communication units 2 are provided in upper portions of the machines M respectively to be detachably attached to the indicator lamps L which indicate the machine states by lights emitted from the indicator lamps L respectively. The machine state management apparatus 3 is installed at a separate position from the machines M. The mobile terminal unit 4 is a smartphone, a tablet PC, or the like which can be carried by the worker etc.

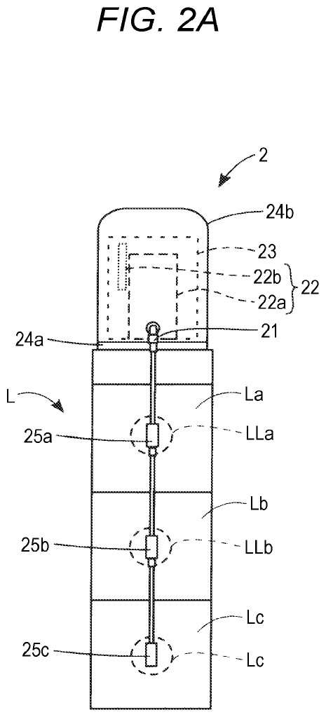

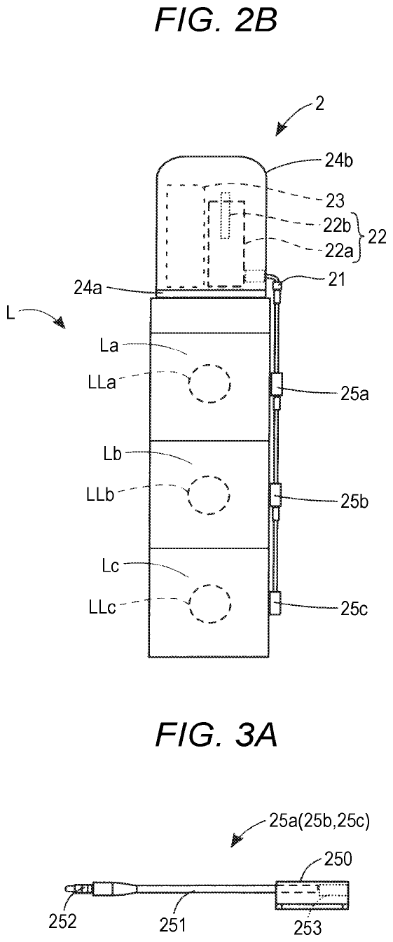

Here, as shown in FIG. 2A and FIG. 2B, each of the indicator lamps L is a general lamp which has a configuration in which semitransparent plastic cases La, Lb and Lc each shaped like a hollow circular cylinder are laminated in three tiers, and light sources LLa, LLb and LLc of LEDs or the like are disposed inside the plastic cases La, Lb and Lc respectively.

The plastic cases La, Lb and Lc are, for example, colored green, yellow and red sequentially from top, and are illuminated or blinked in green, yellow and red respectively by lights emitted from the light sources LLa, LLb and LLc. The indicator lamp L has respective patterns for cases in which the lights of the three colors are turned on individually, cases where the lights of two of the three colors are turned on simultaneously, a case where the lights of the three colors are turned on simultaneously, a case where the lights of the three colors are turned off simultaneously, and cases where the lights of the three colors are blinked individually.

Machine states meant by the respective patterns can be set desirably by the installation side. For example, the case where the lights of the three colors are turned on individually can be set to have the following meanings respectively. That is, the green light means that the machine state of the machine M is normal (in production), the yellow light means that the machine state of the machine M is setting up, and the red light means that the machine state of the machine M is abnormal (failure). Blinking of the green light can be set to mean that the machine state of the machine M is production completed (one product). Any other pattern may be also set desirably.

As shown in FIG. 2A and FIG. 2B, the communication unit 2 is provided with a communication unit terminal 21, a communication processing portion 22, a detection power source portion 23, etc. The communication processing portion 22, the detection power source portion 23, etc. are disposed on a disc-like body portion 24a, and covered with a circularly cylindrical cover 24b. The communication unit terminal 21 is provided to protrude outward from a lower portion of an outer circumference of the cover 24b.

The communication unit 2 is placed on the upper portion of the indicator lamp L, and can be fixed if necessary. Although details will be given later, the optical detection sensor units 25a, 25b and 25c are detachably serial-bus connected to the communication unit terminal 21 of the communication unit 2 so as to droop downward therefrom. The optical detection sensor units 25a, 25b and 25c are disposed on circumferential faces of the plastic cases La, Lb and Lc so that lights of the light sources LLa, LLb and LLc of the indicator lamp L can be detected by the optical detection sensor units 25a, 25b and 25c respectively.

The optical detection sensor units 25a, 25b and 25c detect turning-on, turning-off and blinking of the light sources LLa, LLb and LLc of the indicator lamp L respectively. Since the optical detection sensor units 25a, 25b and 25c can also detect the blinking, the communication unit 2 can detect a variety of machine states.

Although details will be given later, a machine matter detection sensor 51 (see FIG. 4) detecting a matter about the machine M can be also detachably serial-bus connected to the communication unit terminal 21 through a machine matter detection sensor unit 5 (see FIG. 4) in place of the optical detection sensor units 25a, 25b and 25c. Thus, an increase of installation cost of the machine matter detection sensor 51 can be suppressed.

The communication processing portion 22 has a wireless module 22a, a built-in antenna 22b, etc. The wireless module 22a makes wireless communication with the machine state management apparatus 3 in order to transmit signals about the optical detection sensor units 25a, 25b and 25c, a signal about the machine matter detection sensor 51, or the like.

Here, the communication unit 2 is installed in each of the machines M. Therefore, at a factory where the machines M are installed, the communication units 2 may be positioned remotely from the machine state management apparatus 3. There is a fear that each of the communication processing portions 22 of the communication units 2 positioned remotely may be unable to make wireless communication with the machine state management apparatus 3 smoothly.

To solve this problem, configuration can be made so that communication is performed between the communication processing portion 22 of one communication unit 2 and the machine state management apparatus 3 through (by relaying) the communication processing portion 22 of another communication unit 2. The relaying is performed by activating only the communication processing portion 22 of the required communication unit 2. After the relaying, the communication processing portion 22 of the required communication unit sleeps automatically. Thus, power consumption can be suppressed.

The detection power source portion 23 is a dry battery or a rechargeable battery, which supplies a driving current used for operating the optical detection sensor units 25a, 25b and 25c and the wireless module 22a. Since the communication unit 2 is driven by the battery, engineering work in the machine M is unnecessary so that the communication unit 2 can be retrofitted simply.

Here, the optical detection sensor units 25a, 25b and 25c which can be connected to the communication unit terminal 21 of the communication unit 2 are digital sensors. Analog sensors always require the driving current so that the current consumed by each of the analog sensors is large (e.g. 100 μA) in the first place. Accordingly, maintenance of the detection power source portion 23 is complicated. However, the digital sensors require the driving current only during detection. The current consumed by each of the digital sensors is small (e.g. 1.8 μA during detection or 0.3 μA during non-detection) so that maintenance of the detection power source portion 23 is easy.

Each of the optical detection sensor units 25a, 25b and 25c is a photodiode which detects luminous flux (a light quantity (lm (lumen)) passing per unit time) or illuminance (luminous flux (lx (lux)) incident per unit area (1 m²)) of light from the light source LLa, LLb, LLc and outputs an on/off signal (an optical detection signal).

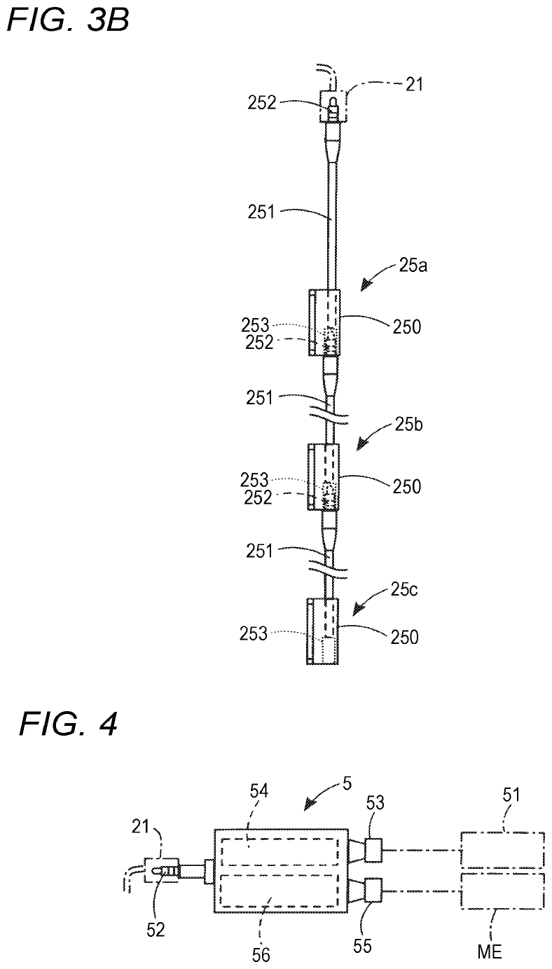

As shown in FIG. 3A, in the optical detection sensor unit 25a, a first optical detection sensor terminal 252 is serial-bus connected to a communication cable 251 provided on one end side of an optical detection sensor 250, and a second optical detection sensor terminal 253 provided on the other end side of the optical detection sensor 250 is serial-bus connected to the communication cable 251. The other optical detection sensor units 25b and 25c also have the same structure.

As shown in FIG. 3B, the first optical detection sensor terminal 252 of the optical detection sensor unit 25a is detachably serial-bus connected to the communication unit terminal 21. Thus, even when the indicator lamp L has been changed to a new one, the change can be coped with by replacing only the optical detection sensor unit with a new optical detection sensor unit corresponding to the newly changed indicator lamp. Accordingly, simple installation can be possible so that an increase of installation cost can be suppressed.

A first optical detection sensor terminal 252 of the optical detection sensor unit 25b is serial-bus connected to the second optical detection sensor terminal 253 of the optical detection sensor unit 25a, and a first optical detection sensor terminal 252 of the optical detection sensor unit 25c is serial-bus connected to a second optical detection sensor terminal 253 of the optical detection sensor unit 25b.

That is, the three optical detection sensor units 25a, 25b and 25c are connected in daisy-chain. Thus, the number of wires from the optical detection sensor units 25a, 25b and 25c can be reduced. A first optical detection sensor terminal of another optical detection sensor unit can be further serial-bus connected to a second optical detection sensor terminal 253 of the optical detection sensor unit 25c so that a plurality of optical detection sensor units can be serial-bus connected in a similar manner or the same manner. Thus, an increase of cost or the number of man-hours for changing the form of the indicator lamp, for example, to a multiple-light indicator lamp including four or more lights can be suppressed.

In addition, the machine matter detection sensor 51 which detects a matter about the machine M and which can be connected to the communication unit terminal 21 of the communication unit 2 is a sensor for outputting an on/off signal (a machine matter detection signal) or a sensor for outputting any other signal (a machine matter detection signal) than the on/off signal. Specifically, for example, a photoelectronic sensor, a distance sensor, a pressure sensor, a proximity switch, a humidity sensor, a CO₂ sensor, an image processing camera, etc. may be used. When the machine matter detection sensor 51 is connected, the following processing can be performed by the machine state management apparatus 3.

For example, the machine state management apparatus 3 can read change of a light quantity shielded by a workpiece conveyed on a conveyor by means of the photoelectronic sensor so as to count the number of produced workpieces. In addition, the machine state management apparatus 3 can read change of a distance to a workpiece conveyed on the conveyor by means of the distance sensor so as to determine kinds of workpieces different in kind. In addition, the pressure sensor is installed inside an air pipe so that the machine state management apparatus 3 can measure change of air pressure.

As shown in FIG. 4, the machine matter detection sensor unit 5 is provided with a machine matter detection sensor terminal 52, a sensor connector 53, a serial conversion portion 54, a power source connector 55, a power source supply portion 56, etc. The machine matter detection sensor terminal 52 is detachably serial-bus connected to the communication unit terminal 21 of the communication unit 2. Thus, the machine matter detection sensor 51 can share the communication unit terminal 21 with the optical detection sensor units 25a, 25b and 25c.

The machine matter detection sensor 51 is connected to the sensor connector 53. The serial conversion portion 54 serially converts the machine matter detection signal from the machine matter detection sensor 51, and communicates with the communication unit terminal 21 of the communication unit 2 through the machine matter detection sensor terminal 52. Since a transistor (photocoupler) is used, a pull-up resistor is provided in the serial conversion portion 54. The pull-up resistor is turned on only when necessary. The pull-up resistor is turned off when unnecessary. With this configuration, power consumption is reduced.

An AC adaptor, a clamp type AC current sensor (two-wire system), an NPN (three-wire system) type sensor, a PNP (three-wire system) type sensor etc. connected to a power source ME of a control panel of the machine M is connected to the power source connector 55. When the clamp type AC current sensor is connected, it is possible to determine whether the machine M is operating or not. The power source supply portion 56 supplies a driving current from the power source connector 55 to the serial conversion portion 54 and the machine matter detection sensor 51.

The configuration of the aforementioned communication unit 2 in which one communication unit terminal 21 is provided and the optical detection sensor units 25a, 25b and 25c and the machine matter detection sensor 51 (the machine matter detection sensor unit 5) are selectively connected to the communication unit terminal 21 has been described.

However, the communication unit 2 may have a configuration in which a plurality of communication unit terminals 21 are provided and the optical detection sensor units 25a, 25b and 25c and the machine matter detection sensor 51 (the machine matter detection sensor unit 5) can be connected to the communication unit terminals 21 simultaneously. Thus, the machine M can be managed by the machine state management apparatus 3 finely.

As shown in FIG. 1, the machine state management apparatus 3 is provided with a management communication portion 31, a management control portion 32, a management information display portion 33, a management power source portion 34, etc. The management communication portion 31 has a wireless module 31a, a built-in antenna 31b, etc. The wireless module 31a makes wireless communication with the communication units 2 and the mobile terminal unit 4 in order to receive or transmit the signals about the optical detection sensor units 25a, 25b and 25c, the signals about the machine matter detection sensors, etc.

The management control portion 32 processes the signals about the optical detection sensor units 25a, 25b and 25c, the signals about the machine matter detection sensors, etc., and displays information about the processed signals etc. on the management information display portion 33. In addition, since communication timings are assigned to the communication units 2 respectively, the management control portion 32 transmits time information to all the communication units 2 which are provided with the same timer. A display example of the management information display portion 33 will be described later. The management power source portion 34 supplies a driving current used for operating the wireless module 31a, the management control portion 32 and the management information display portion 33.

As shown in FIG. 1, the mobile terminal unit 4 is provided with a mobile communication portion 41, a mobile control portion 42, a mobile information display portion 43, a mobile power source portion 44, etc. The mobile communication portion 41 has a wireless module 41a, a built-in antenna 42b, etc. The wireless module 41a makes wireless communication with the machine state management apparatus 3 so as to receive the signals about the optical detection sensor units 25a, 25b and 25c, the signals about the machine matter detection sensors, etc. therefrom

The mobile control portion 42 displays, on the mobile information display portion 43, information of the processed signals about the optical detection sensor units 25a, 25b and 25c, the processed signals about the machine matter detection sensors, etc. received from the machine state management apparatus 3. A display example of the mobile information display portion 43 will be described later. The mobile power source portion 44 is provided with a rechargeable battery which supplies a driving current used for operating the wireless module 41a, the mobile control portion 42 and the mobile information display portion 43.

### (2. Operation of Machinery Management System)

Next, operation of the machinery management system 1 will be described with reference to the drawings. Here, there are a case in which the communication unit 2 starts detection when an inquiry about a machine state is issued from the machine state management apparatus 3, and a case where the communication unit 2 starts detection when the detection power source portion 23 of the communication unit 2 is turned on.

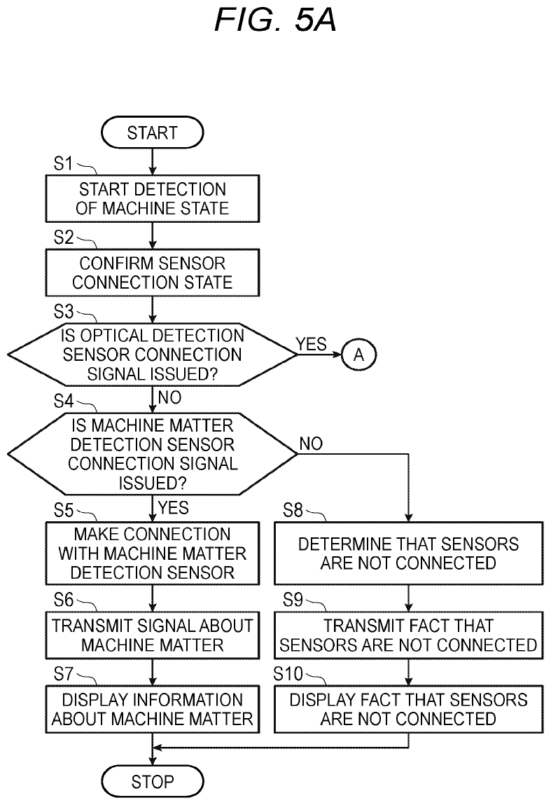

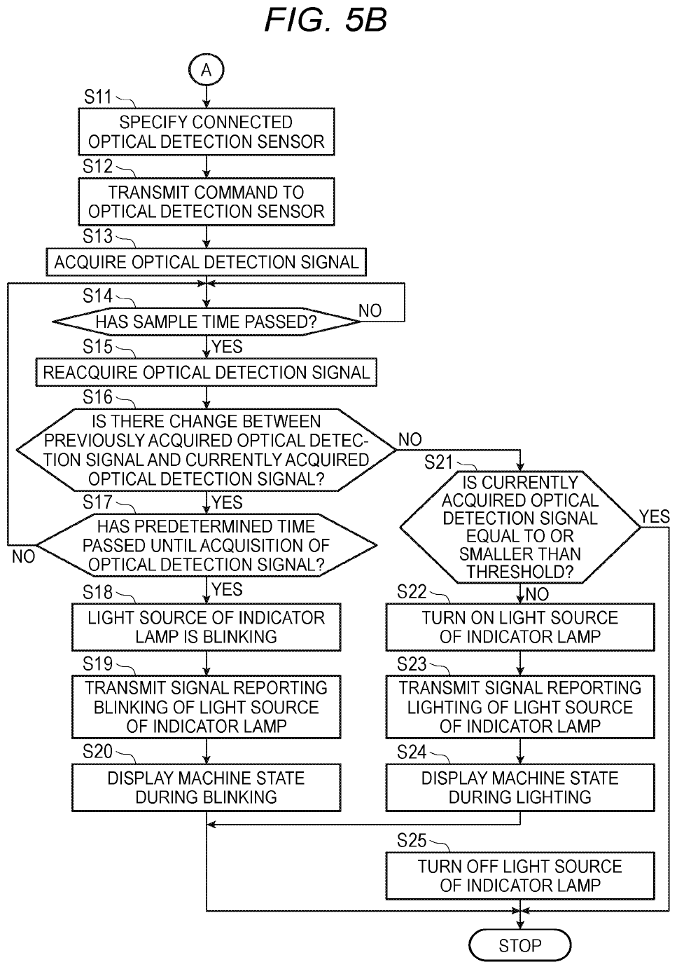

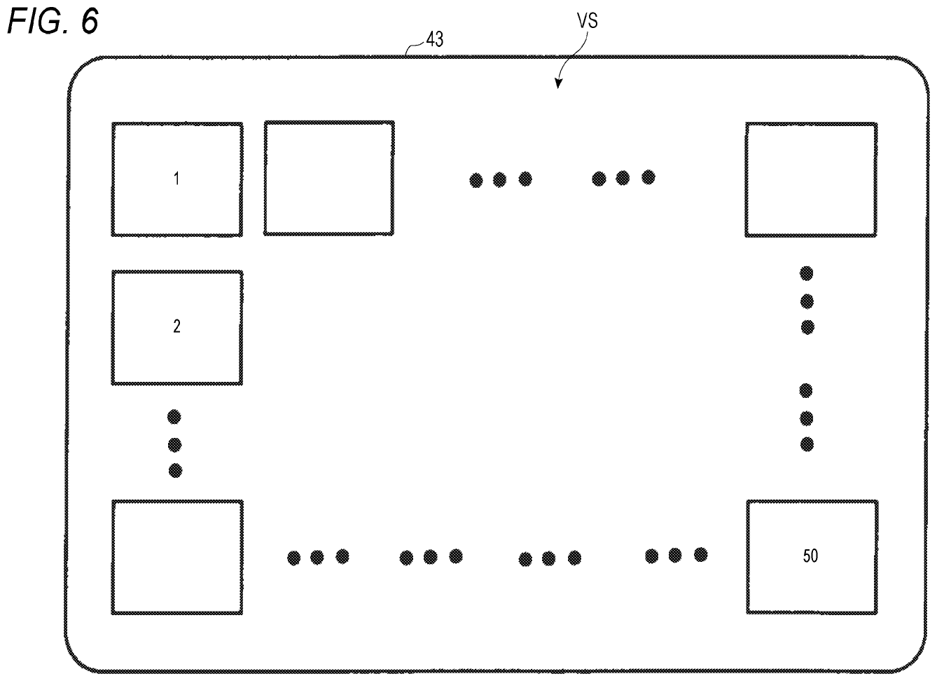

The communication processing portion 22 of the communication unit 2 starts the detection of the machine state in response to the inquiry about the machine state received from the machine state management apparatus 3 or when the detection power source portion 23 is turned on (a step S1 of FIG. 5A). The communication processing portion 22 transmits a sensor connection state confirmation signal through the communication unit terminal 21 (a step S2 of FIG. 5A). Thus, the communication processing portion 22 can surely perform an operation for detecting the machine state.

The communication processing portion 22 determines whether an optical detection sensor connection signal has been replied to the sensor connection state confirmation signal or not (a step S3 of FIG. 5A). When the optical detection sensor connection signal has not been replied, the communication processing portion 22 determines whether a machine matter detection sensor connection signal has been replied or not (a step S4 of FIG. 5A). When the machine matter detection sensor connection signal has been replied, the communication processing portion 22 determines that the machine matter detection sensor 51 is connected (a step S5 of FIG. 5A).

The communication processing portion 22 transmits the detected signal about the machine matter to the machine state management apparatus 3 by wireless (a step S6 of FIG. 5A). The management control portion 32 of the machine state management apparatus 3 displays information about the machine matter on the management information display portion 33 based on the signal about the machine matter received by the management communication portion 31 (a step S7 of FIG. 5A). Then, the processing is terminated.

On the other hand, when determining that the machine matter detection sensor connection signal has not been replied in the step S4, the communication management portion 22 determines that the optical detection sensor unit 25a, 25b, 25c and the machine matter detection sensor 51 are not connected (a step S8 of FIG. 5A). The communication processing portion 22 transmits, to the machine state management apparatus 3, a signal indicating a fact that the sensors are not connected, by wireless (a step S9 of FIG. 5A). The management control portion 32 of the machine state management apparatus 3 receives, through the management communication portion 31, the fact that the sensors are not connected, and displays the received fact on the management information display portion 33 (a step S10 of FIG. 5A). Then, the processing is terminated.

On the other hand, when determining that the optical detection sensor connection signal has been replied in the step S3, the communication processing portion 22 specifies the connected optical detection sensor unit 25a, 25b, 25c based on the replied optical detection sensor connection signal (a step S11 of FIG. 5B). That is, the optical detection sensor connection signal from the optical detection sensor unit 25a, 25b, 25c (a signal “1” when the sensor is connected or a signal “0” when the sensor is not connected) is replied with a given time difference. Therefore, the communication processing portion 22 can specify the connected optical detection sensor unit 25a, 25b, 25c.

In the present example, the optical detection sensor unit 25a, 25b, 25c is connected. Thus, the wireless module 22a gains access to an address for identifying the optical detection sensor unit 25a, 25b, 25c so as to transmit a command for operating the optical detection sensor unit 25a, 25b, 25c to the optical detection sensor unit 25a, 25b, 25c through the communication unit terminal 21 (a step S12 of FIG. 5B). Thus, the optical detection signal of the predetermined optical detection sensor unit can be surely acquired. A case where the optical detection sensor unit 25a detects change of the green light source LLa will be described below for convenience sake.

The communication processing portion 22 acquires an optical detection signal (a signal “1” when the optical detection sensor unit 25a is turned on, or a signal “0” when the optical detection sensor unit 25a is turned off) from the optical detection sensor unit 25a through the communication unit terminal 21 (a step S13 of FIG. 5B). The communication processing portion 22 determines whether a predetermined sample time has passed or not (a step S14 of FIG. 5B). When the predetermined sample time has passed, the communication processing portion 22 reacquires the optical detection signal from the optical detection sensor unit 25a through the communication unit terminal 21 (a step S15 of FIG. 5B).

The sample time is, for example, set at 250 μsec in a case of a mode for detecting blinking and turning on/off as in the present example. The sample time is, for example, set at 1 sec, in a case of a mode for not detecting the blinking but detecting only the turning on/off. The mode can be changed over from one to another in accordance with a mode changeover signal from the machine state management apparatus 3.

The communication processing portion 22 compares the previously acquired optical detection signal and the currently acquired optical detection signal with each other, so as to determine whether there is a change or not between the previously acquired optical detection signal and the currently acquired optical detection signal with a preset threshold as a boundary, i.e. whether the previously acquired optical detection signal and the currently acquired optical detection signal are an optical detection signal exceeding the threshold and an optical detection signal equal to or smaller than the threshold or not (a step S16 of FIG. 5B). The threshold is set in order to prevent misdetection caused by a variation in production of the light source LLa, or misdetection caused by solar light or the like. Setting of the threshold can be changed in accordance with a threshold setting change signal from the machine state management apparatus 3.

When determining that there is a change between the previously acquired optical detection signal and the currently acquired optical detection signal with the threshold as the boundary, the communication processing portion 22 determines whether an acquisition time period of acquiring the optical detection signal for determining presence/absence of blinking (a step S17 of FIG. 5B) has passed or not yet over a predetermined time. When the acquisition time period of acquiring the optical detection signal has not yet passed over the predetermined time, the communication processing portion 22 returns to the step S14 to repeat the aforementioned processing.

On the other hand, when the acquisition time period of acquiring the optical detection signal has passed over the predetermined time, the acquired optical detection signal exceeding the threshold and equal to or smaller than the threshold are present within the predetermined time. Accordingly, the communication processing portion 22 determines that the light source LLa of the indicator lamp Lis blinking (a step S18 of FIG. 5B). According to the determination method, it will go well only if the optical detection signal indicating on/off is transmitted. Accordingly, sensor power consumption can be suppressed. The communication processing portion 22 transmits a signal reporting that the green light source LLa of the indicator lamp L of the machine M is blinking, to the machine state management apparatus 3 by wireless (a step S19 of FIG. 5B).

The management control portion 32 of the machine state management apparatus 3 displays a fact that the machine state is production completed (one product) in the machine M on the management information display portion 33 based on the signal reporting the blinking of the green light source LLa of the indicator lamp L of the machine M and received by the management communication portion 31 (a step S20 of FIG. 5B). Then, the processing is terminated. Thus, an administrator can recognize that the machine state is production completed (one product) in the machine M.

On the other hand, when determining that there is no change between the currently acquired optical detection signal and the previously acquired optical detection signal with the threshold as the boundary in the step S16, the communication processing portion 22 determines whether the currently acquired optical detection signal is equal to or smaller than the threshold or not (a step S21 of FIG. 5B).

When determining that the currently acquired optical detection signal exceeds the threshold, the communication processing portion 22 determines that the light source LLa of the indicator lamp L is turned on (a step S22 of FIG. 5B). The communication processing portion 22 transmits a signal reporting the green lighting of the light source LLa of the indicator lamp L of the machine M to the machine state management apparatus 3 by wireless (a step S23 of FIG. 5B).

Based on the signal reporting the green lighting of the light source LLa of the indicator lamp L of the machine M and received by the management communication portion 31, the management control portion 32 of the machine state management apparatus 3 displays a fact that the machine M is normal (in production) on the management information display portion 33 (a step S24 of FIG. 5B). Then, the processing is terminated. Thus, the administrator can recognize that the machine M is normal (in production).

On the other hand, when determination that the currently acquired optical detection signal is equal to or smaller than the threshold in the step S21, the communication processing portion 22 determines that the light source LLa of the indicator lamp L is turned off (a step S25 of FIG. 5B). Then, the processing is terminated.

### (3. Display Example of Display Device)

Next, display examples of the management information display portion 33 and the mobile information display portion 43 will be described with reference to the drawings. A first display example is a display in which whether the machine state of the machine M detected by the optical detection sensor unit 25a, 25b, 25c in the communication unit 2 is correct or not can be confirmed by the machine state management apparatus 3 and the mobile information display portion 43. The first display example will be described below.

Assume that machines M consisting of units 1 to 50 have been installed in a factory. Numbers of the units of the machines M are not limited in the embodiment. For example, when red lighting of an indicator lamp L is detected by an optical detection sensor unit 25b of a communication unit 2 of the unit 1 of the machines M, the communication unit 2 of the unit 1 of the machines M transmits a signal reporting the red lighting of the indicator lamp L of the unit 1 of the machines M to the machine state management apparatus 3 by wireless.

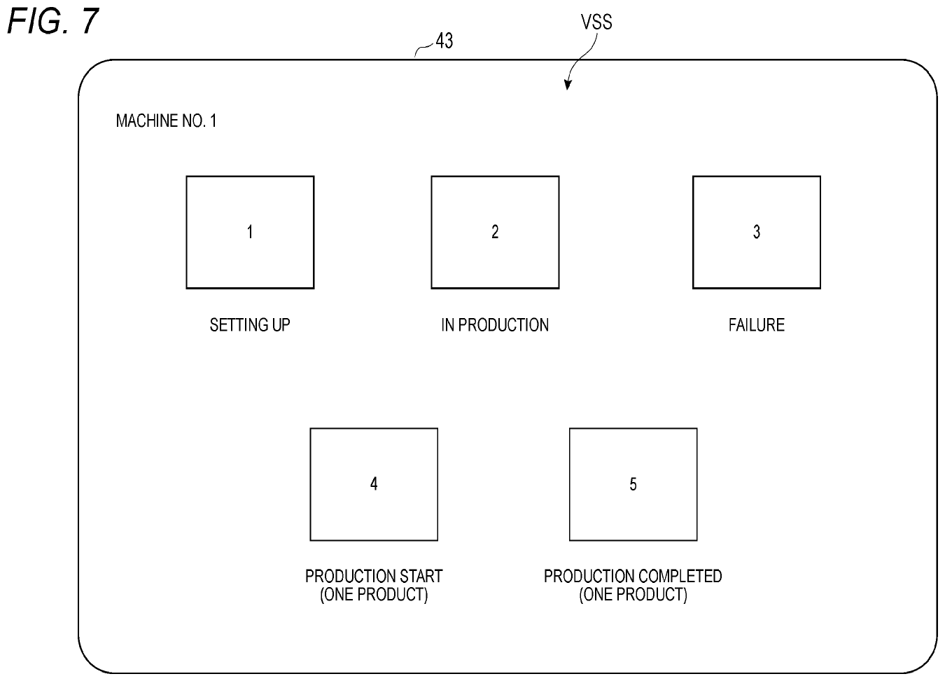

On the other hand, when the worker visually recognizes the red lighting of the indicator lamp L of the unit 1 of the machines M, the worker operates the mobile terminal unit 4 to display a machine selection screen VS on the mobile information display portion 43 of the mobile terminal unit 4, as shown in FIG. 6. Icons of all the machines M consisting of the units 1 to 50 are displayed on the machine selection screen VS. The worker touches the icon of the unit 1 of the machines M from the machine selection screen VS to display a machine state selection screen VSS about the unit 1 of the machines M, as shown in FIG. 7.

“1” setting up, “2” in production, “3” failure, “4” production start (one product), “5” production completed (one product) are indicated on the machine state selection screen VSS. The worker touches the indication of the “3” failure from the machine state selection screen VSS. Thus, the mobile terminal unit 4 transmits a signal reporting the failure of the unit 1 of the machines M to the machine state management apparatus 3 by wireless.

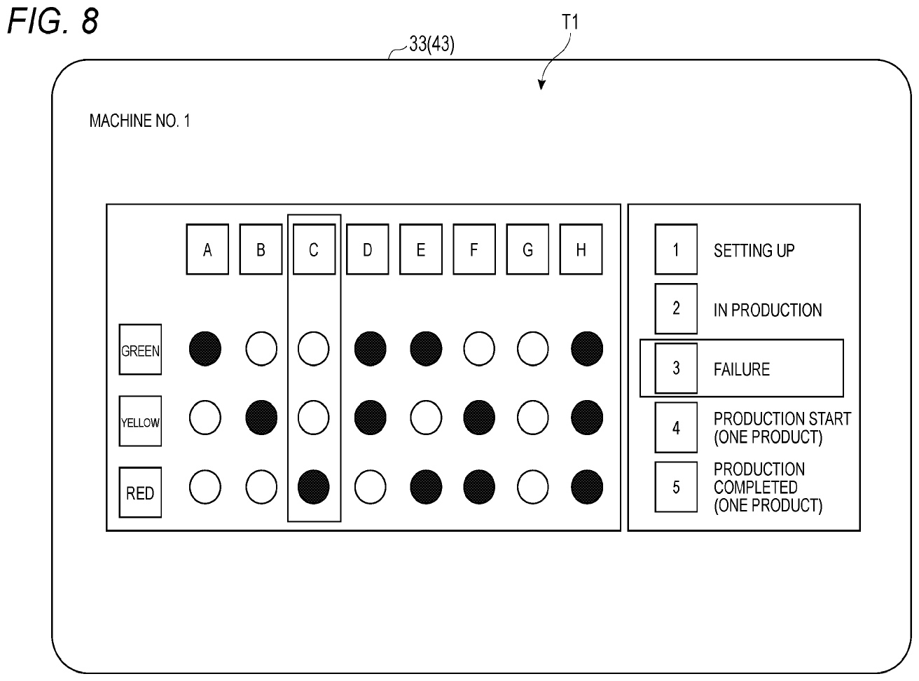

The machine state management apparatus 3 integrates information about the signal reporting the red lighting of the indicator lamp L of the unit 1 of the machines M and received from the communication unit 2, with information about the signal reporting the failure of the unit 1 of the machines M and received from the mobile terminal unit 4. As shown in FIG. 8, the integrated information TI obtained thus is displayed on the management information display portion 33, and the integrated information TI is sent to the mobile communication portion 41 so that the integrated information TI is displayed on the mobile information display portion 43.

In FIG. 8, “A to H” designate patterns of green, yellow and red of the indicator lamp L of the unit 1 of the machines M. A black circle expresses lighting, and a white circle expresses lighting off. Blinking patterns are omitted from FIG. 8. The machine state management apparatus 3 receives the signal reporting the red lighting (abnormality (failure)) of the indicator lamp L of the unit 1 of the machines M from the communication unit 2. Accordingly, the corresponding pattern “C” is framed.

In addition, the machine state management apparatus 3 receives the signal reporting the failure of the unit 1 of the machines M from the mobile terminal unit 4. Accordingly, the corresponding “3” failure is framed. Thus, the administrator can compare the detection information of the communication unit 2 with the visual recognition information of the worker (the mobile terminal unit 4), can surely grasp the machine state of the unit 1 of the machines M, and can issue an instruction to the worker to cope with the problem.

A second display example is a display in which production progress status of the machine M can be confirmed by the machine state management apparatus 3 and the mobile information display portion 43 based on the machine state of the machine M detected by the optical detection sensor units 25a, 25b and 25c in the communication unit 2. The second display example will be described below.

When, for example, production of one product of an item 1 is completed in the unit 1 of the machines M and green blinking of the indicator lamp L is detected by the optical detection sensor unit 25c, the communication unit 2 of the unit 1 of the machines M transmits a signal reporting the green blinking of the indicator lamp L of the unit 1 of the machines M to the machine state management apparatus 3 by wireless.

Based on the signal reporting the green blinking of the indicator lamp L of the unit 1 of the machines M and received from the communication unit 2, the machine state management apparatus 3 recognizes that production of one product of the item 1 has been completed. The aforementioned processing is then repeated, and the number of products of the item 1 is counted. When it reaches a planned production time of the item 1, which has been stored in advance, in the unit 1 of the machines M, the number of products of the item 1 at the point of time is obtained as an actual number of products.

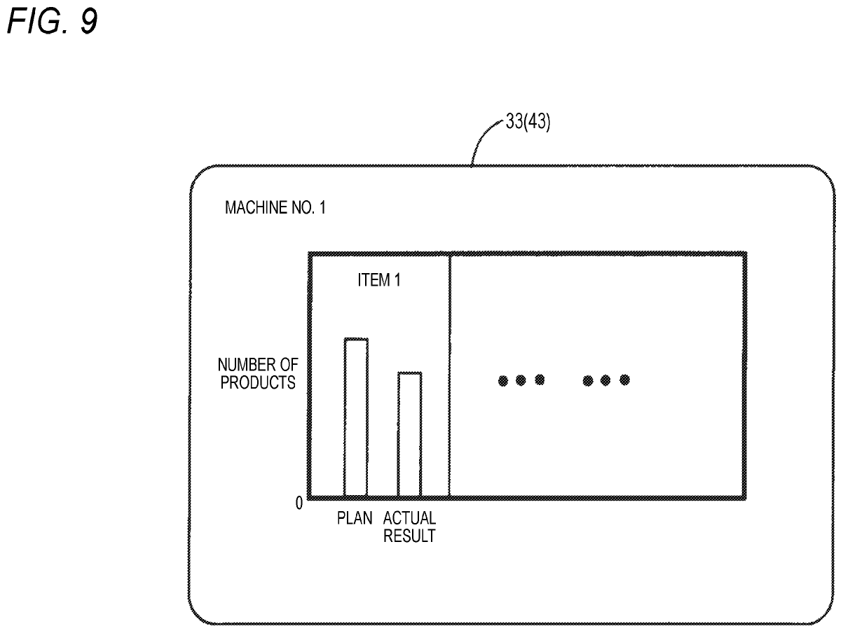

As shown in FIG. 9, the machine state management apparatus 3 displays the planned number of products and the actual number of products in the planned production time of the aforementioned item 1 on the management information display portion 33. The machine state management apparatus 3 may be designed to transmit the planned number of products of the item 1 and the actual number of products of the item 1 to the mobile communication portion 41, and display the planned number of products of the item 1 and the actual number of products of the item 1 on the mobile information display portion 43. Thus, the administrator and the worker can grasp production delay.

In addition, the machine state management apparatus 3 obtains a value by dividing an integrated value of the planned number of products of the item 1 and a machine cycle time of the item 1 by the planned production time of the item 1, i.e. planned operational availability of the item 1. Further, the machine state management apparatus 3 obtains a value by dividing an integrated value of the actual number of products of the item 1 and the machine cycle time of the item 1 by the actual production time of the item 1, i.e. actual operational availability of the item 1.

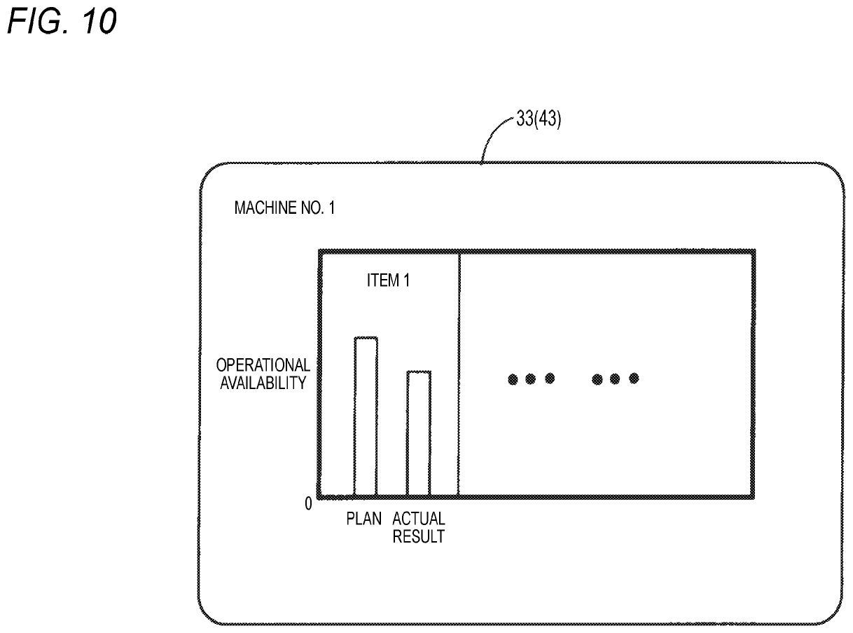

As shown in FIG. 10, the machine state management apparatus 3 displays the planned operational availability of the item 1 and the actual operational availability of the item 1 on the management information display portion 33. The machine state management apparatus 3 may be designed to transmit the planned operational availability of the item 1 and the actual operational availability of the item 1 to the mobile communication portion 41 so as to display the planned operational availability of the item 1 and the actual operational availability of the item 1 on the mobile information display portion 43. Thus, the administrator and the worker can improve production.

In addition, when the production time of the item 1 in the unit 1 of the machines M reaches a predetermined time (an actual operating time), the machine state management apparatus 3 obtains the number of products of the item 1 at that point of time. The machine state management apparatus 3 obtains a planned operating time based on the obtained number of products of the item 1 and the machine cycle time of the item 1.

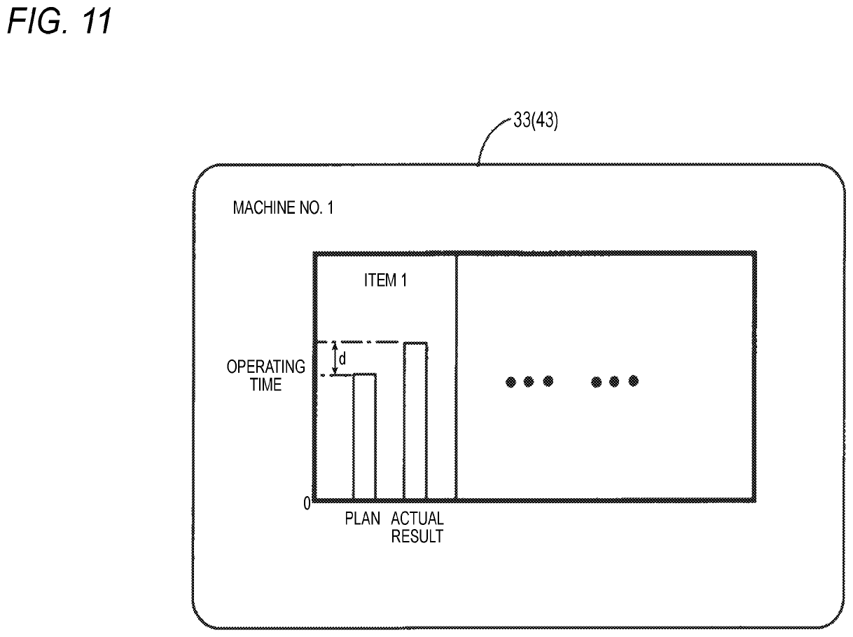

As shown in FIG. 11, the machine state management apparatus 3 displays the planned operating time of the item 1 and the actual operating time of the item 1 on the management information display portion 33. The machine state management apparatus 3 may be designed to transmit the planned operating time of the item 1 and the actual operating time of the item 1 to the mobile communication portion 41 so as to display the planned operating time of the item 1 and the actual operating time of the item 1 on the mobile information display portion 43. Thus, the administrator and the worker can directly grasp production delay of the item 1 from a difference d between the actual operating time and the planned operating time.

In addition, the optical detection signals of the optical detection sensor units 25a, 25b and 25c, a lighting continuing time of the indicator lamp L, a time instant at which lighting of the indicator lamp L changes from off to on, internal temperature of the communication unit 2, ID of the machine M, a residual battery level of the detection power source portion 23, radio wave intensity of the wireless module 22a, etc. are displayed on the management information display portion 33 and the mobile information display portion 43. When the residual battery level of the detection power source portion 23 or the radio wave intensity of the wireless module 22a lowers, the lowering of the residual battery level or the radio wave intensity of the wireless module 22a is displayed together with a warning etc.

### (4. Others)

In the aforementioned embodiment, each of the optical detection sensor units 25a, 25b and 25c is used as a digital sensor detecting luminous flux or illuminance of light from a corresponding one of the light sources 23a, 23b and 23c. However, the optical detection sensor unit 25a, 25b, 25c may be used as a digital sensor which detects a color, i.e. green, yellow, or red, of light transmitted through the plastic case La, Lb, Lc. The applicable indicator lamp L of the communication unit 2 is not limited to the light sources of the three colors. However, any number of color light sources or one light source whose emission color can change can be also applied.

What is claimed is:

1. A machinery management system comprising:
at least one optical detection sensor unit including:
an optical detection sensor that is disposed to face an indicator lamp configured to indicate a machine state and that detects a light from the indicator lamp; and
a first optical detection sensor terminal that is connected to the optical detection sensor;
at least one communication unit including:
a body portion that is disposed on the indicator lamp;
a communication unit terminal that is detachably attached to the first optical detection sensor terminal; and
a communication processing portion that is configured to connect with the optical detection sensor, such that an optical detection signal generated by the optical detection sensor is wirelessly communicated; and
at least one machine state management apparatus including:
a management communication portion that is configured to wirelessly communicate with the communication processing portion; and
an information display portion that is configured to display an information of the optical detection signal generated by the optical detection sensor, the information being communicated through the management communication portion.

2. The machinery management system according to claim 1, wherein the optical detection sensor unit further includes a second optical detection sensor terminal that is configured to connect in a serial-bus with the first optical detection sensor terminal of another optical detection sensor unit different from the optical detection sensor unit; and
wherein the optical detection sensor unit and said another optical detection sensor unit are connected in a daisy-chain with the communication unit terminal.

3. The machinery management system according to claim 1, wherein the communication processing portion transmits an address that is required to identify the optical detection sensor and a command that is required to operate the optical detection sensor to the optical detection sensor through the first optical detection sensor terminal, in response to an inquiry from the management communication portion.

4. The machinery management system according to claim 1, wherein the communication processing portion determines whether the indicator lamp is blinking, based on the optical detection signal generated by the optical detection sensor.

5. The machinery management system according to claim 4, wherein the communication processing portion determines that the indicator lamp is blinking, when the optical detection signal exceeding a predetermined threshold provided in the optical detection signal of the optical detection sensor and the optical detection signal equal to or smaller than the predetermined threshold exist within a predetermined time.

6. The machinery management system according to claim 5, wherein the communication processing portion is configured to change the predetermined threshold of the optical detection signal, based on a predetermined threshold setting change signal received from the management communication portion.

7. The machinery management system according to claim 1, further comprising:
a plurality of optical detection sensor units including the at least one optical detection sensor unit; and
a plurality of communication units including the at least one communication unit;
wherein the at least one communication unit of the communication units and the machine state management apparatus are communicated with each other through another communication unit different from the at least one communication unit.
